(19) United States
(12) Patent Application Publication
(10) Pub. No.: US 2007/0001623 A1
(43) Pub. Date: Jan. 4, 2007

(54) Lamp End of Life Indicator

(76) Inventor: Neil Dudley, Chelmsford (GB)

Correspondence Address: BARLEY SNYDER, LLC, 1000 WESTLAKES DRIVE, SUITE 275, BERWYN, PA, 19312, US

(21) Appl. No.: 11/426,373

(22) Filed: Jun. 26, 2006

(30) Foreign Application Priority Data
Jul. 1, 2005 (GB) 0513486.1

(51) Int. Cl. H05B 41/36

(52) U.S. Cl. 315/291

(57) ABSTRACT

The apparatus signals when a high intensity discharge lamp is nearing the end of its operational life. The apparatus includes a lamp drive signal source that provides a drive signal to the high intensity discharge lamp. The lamp drive signal source has a measurable drive parameter. A controller controls the operation of the high intensity discharge lamp. The controller is capable of delaying activation of the lamp drive signal source in response to a measured value of the operating voltage of the high intensity discharge lamp.

### FIELD OF THE INVENTION

This invention relates to an apparatus for signaling when a high intensity discharge (HID) lamp is nearing the end of its operational life and, more particularly, to an apparatus for signaling when a high intensity discharge (HID) lamp that forms part of a lighting system is nearing the end of its operational life.

### BACKGROUND OF THE INVENTION

Public lighting systems are generally provided by a lighting service provider. These lighting systems typically comprise a plurality of HID lamps. It is desirable to replace the HID lamps in the lighting system before they fail, since a failed HID lamp can result in a dangerous environment in an area around the failed HID lamp.

It is known for lighting service providers to replace the HID lamps in a particular region of the lighting system on a preventative maintenance basis. A problem with this approach is that the HID lamps may be replaced well before the end of their useful lives. For example, a HID lamp replaced on a preventative maintenance basis is typically only about 70% through its useful life. This approach therefore makes the lighting system expensive to operate.

Another approach taken by lighting service providers is to replace the HID lamps when they are reported to have failed. This approach involves a high cost per HID lamp due to the amount of time taken for maintenance staff to reach the location of the failed HID lamp. Because the replacement staff may have to visit a particular region several times a month to replace individual HID lamps as they fail, this approach additionally makes the lighting system expensive to operate.

A HID lamp is typically operated by an alternating current (AC) drive voltage applied across the HID lamp and an inductor in series. The electrical power input to the lamp, and hence the output power of the lamp, is controlled by a drive parameter of the AC drive voltage in such a way that the lamp intensity varies monotonically in response to monotonic variations in the drive parameter. Usually the electric power input to the lamp is controlled by controlling the magnitude or frequency of the AC drive voltage, although other drive parameters could be controlled. A given HID lamp will have a predetermined preset output power level at which it is designed to operate. It is known that as the age of a HID lamp increases, the terminal voltage measurable across the HID lamp increases. As a result, the output power level of the HID lamp decreases over time for a given drive parameter.

In addition to the normal progressive deterioration of the HID lamp due to burning, there are other reasons for the HID lamp to fail, such as mechanical damage to the outer envelope or burner tube or failure of the seal within the lamp. These causes for failure typically give rise to catastrophic failure of the lamp with no or minimal warning. The invention does not address these types of failures. These types of failures, however, tend to affect only a minority of HID lamps, and typically only after the HID lamps have experienced extended burning hours and have a raised operating voltage.

Many HID lamp designs include a control circuit that controls, among other things, the output power of the HID lamp. The controller may vary the drive parameter of the AC drive voltage in an attempt to achieve constant or near constant power within the HID lamp, despite any increase in the terminal voltage resulting from the aforesaid ageing of the HID lamp. There is however a limit to the adjustment range of the drive parameter. As the HID lamp continues to age, the drive parameter eventually reaches the limit of the adjustment range. At this point, the control circuit is no longer able to maintain the output power of the HID lamp at the preset designed power level. This may result in the intensity of the light transmitted by the HID lamp reducing or rapidly varying.

As the lamp ages further, an active control circuit typically maintains the drive parameter at the upper limit of its adjustment range in an attempt to maintain the output power of the HID lamp, as close as possible to the design output power level. During such a time, however, the HID lamp output power falls progressively shorter and shorter of the designed output power, as the voltage across the HID lamp increases. Eventually the power in the HID lamp drops below the level needed to sustain illumination and the lamp extinguishes. It is known to use the control circuit to signal to a central location (i.e. a switching control room) that an individual HID lamp is failing. For various reasons, however, such an approach still requires high cost maintenance programs.

### BRIEF SUMMARY OF THE INVENTION

The invention provides an apparatus for signaling when a high intensity discharge lamp is nearing the end of its operational life. The apparatus includes a lamp drive signal source that provides a drive signal to the lamp. The lamp drive signal source has a measurable drive parameter. A controller controls the operation of the lamp. The controller is capable of delaying activation of the lamp drive signal source in response to a measured value of the operating voltage of the high intensity discharge lamp.

The invention further provides a method for signaling when a high intensity discharge lamp is nearing the end of its operational life wherein the high intensity discharge lamp has a measurable operating voltage. The method comprises the steps of: supplying the high intensity discharge lamp with a drive signal having a measurable drive parameter; and delaying supply of the drive signal to the high intensity discharge lamp in dependence on the operating voltage of the high intensity discharge lamp.

### BRIEF DESCRIPTION OF THE DRAWINGS

An example of an embodiment of the invention will now be described with reference to the accompanying figures, wherein:

FIG. 1 is a schematic circuit diagram of an apparatus for signaling the operational status of an HID lamp according to the invention.

### DETAILED DESCRIPTION OF THE INVENTION

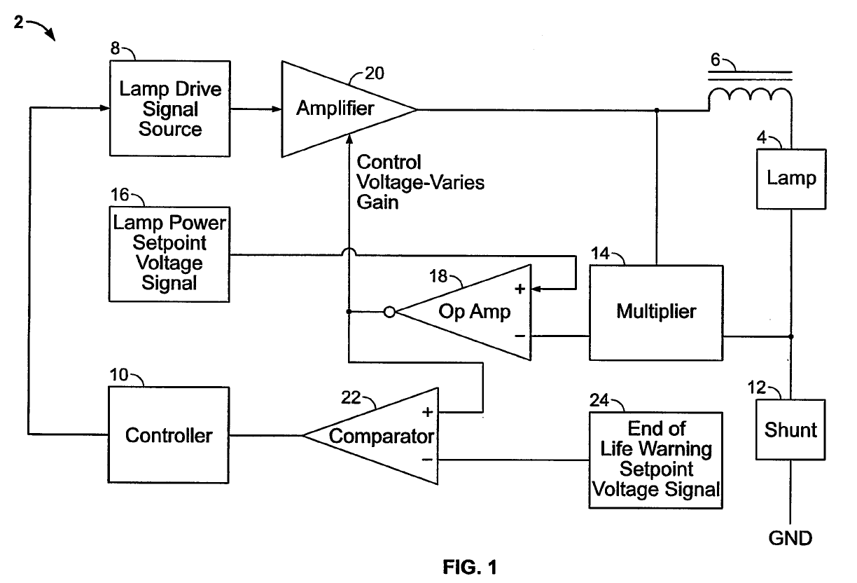

FIG. 1 shows a schematic circuit diagram of an apparatus 2 for signaling the operational status of a lamp 4, such as an HID lamp, according to the invention. As shown in FIG. 1, the lamp 4 is connected in series with an inductor 6. The lamp 4 is operated by the application of an AC voltage across the lamp 4 and inductor 6. The AC voltage is supplied to the lamp 4 by a lamp drive signal source 8. The electrical power input to the lamp 4, and hence the power output of the lamp 4, is controlled by controlling a drive parameter such as the magnitude or frequency of the AC voltage supplied by the lamp drive signal source 8. The lamp intensity varies monotonically in response to monotonic variations of the drive parameter.

As the lamp 4 ages, its output voltage increases. This means that for a given value of the drive parameter, the output power of the lamp 4 will decrease with age. The apparatus 2 further comprises a controller 10 in the form of a control circuit which varies the drive parameter which seeks to achieve constant or near constant output power in the lamp 4 despite such increases in output voltage.

A shunt 12 measures the output current of the lamp 4 and is connected to ground GND. A multiplier 14 calculates the lamp output power based on the output current measured by the shunt 12 and the AC drive voltage provided to the lamp 4 by the lamp drive signal source 8. A lamp power set point voltage signal 16 is fed to an additive input of an operational amplifier (Op Amp) 18. The value of the lamp power set point voltage signal 16 is based on the optimum output voltage for the lamp 4 and is used to determine the instantaneously prevailing output power level of the lamp 4. The multiplier 14 feeds a signal to the subtracting input of the operational amplifier 18 based on the measured output power of the lamp 4.

If the measured output power is lower than the preset output power of the lamp 4, the operational amplifier 18 triggers an amplifier 20 to amplify the AC voltage supplied by the lamp drive signal source 8 to increase the drive parameter within the limits of a predetermined adjustment range. The control circuit 10 thus enables the drive parameter to seek constant or near constant lamp output power, despite the increase in output voltage of the lamp 4.

At some point in the life of the lamp 4, the drive parameter will reach the end of its adjustment range, and the controller 10 will no longer be able to maintain the lamp power at a constant set point voltage determined by the lamp power set point voltage signal 16. The controller 10 therefore includes a comparator 22 to the subtracting input of which is fed an end of life warning set point voltage signal 24. The magnitude of the end of life warning set point voltage signal 24 is identical or similar to a lamp operating voltage that indicates impending lamp failure through ageing.

The multiplier 14 also feeds a signal into the comparator 22 via the operational amplifier 18, which signal is based on the measured output power of the lamp 4. The comparator 22 compares the measured output power with a set point output power derived from the end of life warning set point voltage signal 24. If the measured output power of the lamp 4 is less than or equal to the set point output power of the lamp 4 the controller 10 delays activation of the lamp drive signal source 8. This results in the lamp 4 switching on a predetermined time after activation of the system 2. As a result, by simply visually inspecting the lamp 4, it is possible to determine whether or not it is nearing the end of its useful life. The controller 10 may further include a memory whose function is to recall the state of the comparator 22 at last use.

By means of the invention, activation of the drive signal source 8 may be delayed in dependence on the operating voltage of the lamp 4. As a result the lamp 4 switches on a predetermined time after the controller 10 becomes operational. When the apparatus 2 of the invention forms part of, for example, a public lighting system, the controllers 10 of the lamps 4 in the system that are reaching the ends of their lives will, on start-up of the system, illuminate some time after the healthy lamps in the system.

A lighting service provider may therefore at a lighting-up time readily observe a group of the lamps 4, such as all the lamps 4 in a particular street, and straightforwardly identify the lamps 4 which are nearing the ends of their lives. This requires little or no skill, while allowing maintenance staff to replace as many of the lamps 4 as necessary, on an economical basis. In a lighting system, such as a public lighting system, comprising a plurality of the lamps 4, it is therefore possible for replacement staff to quickly and easily identify which of the lamps 4 require replacing before they actually fail. The apparatus of the invention therefore exhibits numerous advantages over the prior art.

The foregoing illustrates some of the possibilities for practicing the invention. Many other embodiments are possible within the scope and spirit of the invention. For example, in the embodiment described herein with reference to FIG. 1, the drive parameter is increased as the operating voltage of the lamp decreases. In an alternative embodiment of the invention, however, the drive parameter may be held constant, in which case the lamp light output will decrease with age as soon as the operating voltage of the lamp starts to increase. In such an embodiment, the controller 10 may monitor the lamp output power level and may delay actuation of the lamp drive signal source 8 when the lamp output power has fallen to a predetermined level. It is, therefore, intended that the foregoing description be regarded as illustrative rather than limiting, and that the scope of the invention is given by the appended claims together with their full range of equivalents.

What is claimed is:

1. An apparatus for signaling when a high intensity discharge lamp is nearing the end of its operational life wherein the high intensity discharge lamp has a measurable operating voltage, the apparatus comprising:
a lamp drive signal source for providing a drive signal to the high intensity discharge lamp, the lamp drive signal source having a measurable drive parameter; and
a controller for controlling operation of the high intensity discharge lamp, the controller being capable of delaying activation of the lamp drive signal source in response to a measured value of the operating voltage of the high intensity discharge lamp.

2. The apparatus according to claim 1, further comprising:
a first measuring device for measuring a magnitude of output power in the high intensity discharge lamp;
a comparator for comparing the magnitude of the measured output power of the high intensity discharge lamp with a predetermined output power magnitude; and
the controller being capable of delaying activation of the lamp drive signal source in response to the difference between the magnitude of the measured output power and the predetermined output power magnitude.

3. The apparatus according to claim 2, further comprising a second measuring device for measuring a magnitude of the drive parameter of the drive signal, the controller delaying activation of the lamp drive signal source in dependence on the magnitude of the drive parameter of the drive signal.

4. The apparatus according to claim 2, wherein the controller is arranged to delay actuation of the lamp drive signal source if the magnitude of the measured output power is less than the predetermined output power magnitude.

5. The apparatus according to claim 2, wherein the controller is arranged to delay actuation of the lamp drive signal source if the magnitude of the drive parameter of the drive signal reaches a predetermined value.

6. A method for signaling when a high intensity discharge lamp is nearing the end of its operational life wherein the high intensity discharge lamp has a measurable operating voltage, the method comprising the steps of:
supplying the high intensity discharge lamp with a drive signal having a measurable drive parameter; and
delaying supply of the drive signal to the high intensity discharge lamp in dependence on the operating voltage of the high intensity discharge lamp.

7. The method according to claim 6, further comprising the steps of:
measuring a magnitude of output power of the high intensity discharge lamp;
comparing the measured magnitude of the output power of the high intensity discharge lamp with a predetermined output power magnitude;
producing a signal in response to the difference in the measured magnitude of the output power and the predetermined output power magnitude; and
delaying supply of the drive signal to the high intensity discharge lamp in dependence on the signal.

8. The method according to claim 7, wherein the drive signal supplied to the high intensity discharge lamp is delayed when the measured magnitude of the output power of the high intensity discharge lamp is less than the predetermined output power magnitude.

9. The method according to claim 6, further comprising the step of measuring a magnitude of a drive parameter of the drive signal.

10. The method according to claim 9, wherein the drive signal supplied to the high intensity discharge lamp is delayed in response to the magnitude of the drive parameter of the drive signal.

11. The method according to claim 1 0, wherein the drive signal supplied to the high intensity discharge lamp is delayed when the drive parameter exceeds a predetermined value.
